(19) United States
(12) Patent Application Publication
(10) Pub. No.: US 2017/0336870 A1
(43) Pub. Date: Nov. 23, 2017

(54) FOOT GESTURE-BASED CONTROL DEVICE

(71) Applicant: Orpyx Medical Technologies Inc., Calgary (CA)

(72) Inventors: Julia Breanne Everett, Calgary (CA); Llewellyn Lloyd Turnquist, Calgary (CA); Travis Michael Stevens, Calgary (CA); Daryl David Coutts, Calgary (CA); Marcel Groenland, Calgary (CA)

(73) Assignee: Orpyx Medical Technologies Inc., Calgary, AB (CA)

(21) Appl. No.: 15/521,023

(22) PCT Filed: Oct. 23, 2015
(86) PCT No.: PCT/CA2015/051083

§ 371 Date: Apr. 21, 2017

Related U.S. Application Data
(60) Provisional application No. 62/067,933, filed on Oct. 23, 2014.

(51) Int. Cl. G06F 3/01; A43B 3/00; A43B 13/38; G02B 27/01

(52) U.S. Cl. CPC G06F 3/016; G06F 3/017; G02B 27/0176; A43B 3/00; G02B 27/0172; A43B 13/38; G02B 2027/014

(57) ABSTRACT

A hands-free, heads up and discrete system and method for controlling a peripheral device using foot gestures is provided. The system includes a foot-based sensory device that includes one or more sensors, such as pressure sensors, gyroscopes, and accelerometers, that receive sensory information from a user's foot, interpret the information as being linked to specific commands, and transmit the commands to at least one display device for controlling the display device. The system also includes a feedback system for providing tactile, visual and/or auditory feedback to the user based on the actions performed, information provided by the display device and/or information provided from another user.

### FIELD OF THE INVENTION

The invention generally relates to hands-free control, and more particularly to hands-free control of devices using foot gestures and/or foot pressure.

### BACKGROUND OF THE INVENTION

There are innumerable instances where the need for hands-free control of and/or feedback from peripheral devices is desired, particularly in medical and occupational applications. Many heads up displays (HUDs) and head/helmet mounted displays (HMDs) do not generally allow for hands-free control, since they often require a hand or finger for controlling the device through finger-push or tap controls.

While voice-activated systems allow for hands-free control of devices, there are numerous drawbacks and limitations of voice-activated systems. In particular, voice-activated systems generally have deficiencies with the quality and speed of voice recognition and do not allow for multiple users located near each other to employ voice-activated systems concurrently. Voice-activated systems are relatively power-intensive since resources must be continuously dedicated to actively listening for voice commands, and typically users need to go through training prior to using the voice-activated system. Furthermore, voice-activated systems do not allow for discrete or covert commands, which can be important for certain uses, particularly in medical settings, and there may be privacy and security issues with voice-activated systems that rely on cloud based computing.

As such, there is a general need for a hands-free control system that allows for cover, discrete and secure control of a peripheral device. More specifically, there is a need for a system wherein a control system senses various foot gestures of a user and converts the foot gestures to commands for controlling a peripheral device, thereby allowing for hands-free and covert, discrete and secure control.

The Applicant's PCT Publication No. WO 2012/055029, incorporated herein by reference, describes a system that receives pressure readings from across a foot using an input device, such as an insole having a plurality of pressure sensors, and transmits the pressure readings to a receiving device, such as a wristband or display, which processes and displays the pressure readings to determine the likelihood of tissue damage at an area on the foot in order to prevent injury to a user.

In addition, a review of the prior art reveals U.S. Pat. No. 7,186,270 which describes a foot-operated controller for controlling a prosthetic limb using a plurality of pressure sensors mounted at selected locations on a substrate that is located on or within the insole of a shoe. This system offers one-way communication between one user and the prosthetic limb, and does not allow for two-way communication for the user to receive feedback from the prosthetic limb, nor two-way communication between two or more users.

WO 01/86369 descries a shoe sensor for surgical control that may be used in combination with a surgical foot pedal having a tilt sensor for determining angular movement, and a cuff for supporting the tilt sensor on the user's foot in order to determine the lateral angle movement of the user's foot. U.S. Pat. No. 8,822,806 describes a foot-operable apparatus and method comprising at least one accelerometer sensor and at least one pedal-type component operable by a user to produce one or more control signals.

The prior art also includes various monitoring and feedback systems such as WO 2006/016369 which describes a sports system for insertion into a shoe that comprises at least one pressure sensor that measures the force applied on a user's foot and provides feedback based on input to the system to encourage an optimal target weight profile for the foot. WO 2013/027145 describes the structure of a sensorized mat for measuring the contact, intensity of tactile action and position of a user's foot. WO 2009/070782 describes a system and method for sensing pressure at a plurality of points of a user's foot, including its bones, joints, muscles, tendons and ligaments. U.S. Pat. No. 6,836,744 describes a portable system for analyzing human gait, and WO 2001/035818 describes a sensor for measuring foot pressure distributions.

### SUMMARY OF THE INVENTION

In one aspect, there is provided a foot gesture-based control system comprising a sensory device having at least one sensor for generating an input based on a foot gesture or a force applied by at least one part of a user's foot; a processor for receiving the input from the sensory device and determining any output action; a transmitter for transmitting the output action from the processor wirelessly to at least one display device for controlling the at least one display device; and a feedback device in communication with the processor for receiving the output action to provide feedback to the user.

In certain embodiments, the transmitter is a transmitter/receiver, and the processor receives information from the at least one display device and/or a secondary device through the transmitter/receiver for providing feedback to the user through the feedback device.

In certain embodiments, the input device is a shoe insole, a sock, a shoe or a foot mat.

In certain embodiments, the input device is a shoe insole and there is an array of pressure sensors distributed throughout the insole.

In certain embodiments, the at least one sensor is any one of or combination of a pressure sensor, accelerometer and gyroscope.

In certain embodiments, the feedback device provides tactile feedback to the user's foot.

In certain embodiments, the peripheral device is a head- or helmet-mounted display (HMD) or a heads up device (HUD).

In certain embodiments, multiple foot gesture based control systems can communicate discretely with each other by sending signals using foot gestures and receiving signals through the feedback device.

Another aspect of the invention is a method for controlling a display device based on foot gestures and/or foot forces of a user comprising the steps of generating an input based on a foot gesture or foot force of the user using at least one sensor; interpreting the input as a foot gesture linked to a specific command; commanding a display device to perform the specific command; and providing feedback to the user based on the command performed and/or information received from an external system.

Another aspect of the invention is a foot gesture-based controller for hands-free selection of a plurality of menu commands on a computer, the controller comprising: an input device including a plurality of sensors configured to recognize a plurality of foot gestures, wherein each unique foot gesture of the plurality of foot gestures causes a unique sensor output signature configured to initiate a unique menu command from the plurality of menu commands on the computer; and a transmitter for transmitting the unique sensor output signature to the computer for initiation of the unique menu command.

In certain embodiments, the input device is a shoe insole and there is an array of pressure sensors distributed throughout the insole.

In certain embodiments, the plurality of sensors includes any one of or combination of a pressure sensor, an accelerometer and a gyroscope.

In certain embodiments, the controller further comprises a feedback device for providing feedback based on the unique sensor output signature and/or the generated command.

In certain embodiments, the feedback device provides tactile feedback to the user's foot.

In certain embodiments, the computer is a heads-up device (HUD) or includes a head- or helmet-mounted display.

In certain embodiments, the plurality of foot gestures includes any combination of two or more of the following: downward pressure of the tip of the hallux, downward pressure of the hallux combined with flexion of the hallux toward the ball of the foot, downward pressure of the hallux combined with extension of the hallux away from the ball of the foot hallux extension, downward pressure of substantially the entire ball of the foot, downward pressure of the left side of the ball of the foot, downward pressure of the right side of the ball of the foot, and downward pressure of the heel.

In certain embodiments, the menu commands are displayed in a main menu and in one or more submenus.

In certain embodiments, the menu commands are selected from the group consisting of: Open Main Menu, Scroll Up/Down, Return/Enter, Exit, Take a Photo, Take A Screenshot, Record Video, Stop Recording Video, Alphanumeric Character Insertion, Backspace/Delete, Zoom In, Zoom Out, Toggle, Increase Volume, Decrease Volume, Go Forward, Go Back, Increase Intensity, and Decrease Intensity.

In certain embodiments, the foot gestures recognized by the input device are pre-selected from a survey for ease of performance by a survey group of users testing the controller, and wherein the easiest foot gestures determined by the survey group are assigned to the most commonly used commands.

In certain embodiments, the transmitter is a wireless transmitter.

In certain embodiments, the controller embodiments described herein are for use in providing patient data to a surgeon during surgery.

In certain embodiments, the patient data is transmitted from a patient monitor to the computer wirelessly.

In certain embodiments, the patient data includes any one of or a combination of vital signs data, a real time video of a different field of view of the patient, and a surgical model based on the anatomy of the patient.

In certain embodiments, the vital signs data includes any one of or a combination of blood pressure, pulse rate, body temperature, respiration rate and dissolved oxygen level.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a schematic diagram of a control system in accordance with one embodiment of the invention.

FIG. 2 is a top view, exploded view and front view of an exemplary foot-based sensory device in accordance with one embodiment of the invention.

FIG. 3 is a flowchart illustrating a method of controlling a display device using a control system in accordance with one embodiment of the invention.

FIG. 4 is a flowchart illustrating a method of controlling a display device using a control system wherein feedback is provided to a second user in accordance with one embodiment of the invention.

FIG. 5 is a schematic diagram of how first and second control systems can communicate with each other in accordance with one embodiment of the invention.

FIG. 6 is a schematic diagram of how first and second control systems can communicate with each other and with a common display device in accordance with one embodiment of the invention.

### DETAILED DESCRIPTION OF THE INVENTION

With reference to the figures, a system and method for controlling a peripheral device using foot gestures is described.

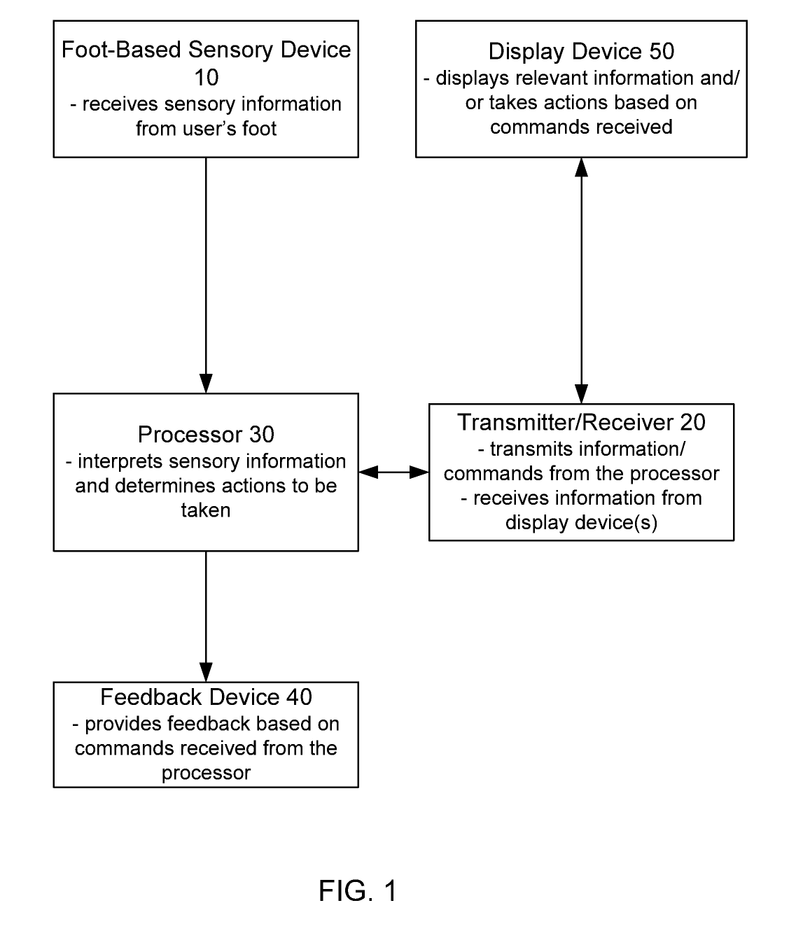

Referring to FIG. 1, the control system generally comprises a sensory device 10 for sensing foot movements and changes in foot or plantar pressure; a processor 30 in communication with the sensory device for processing/interpreting sensory information and converting it into discrete commands and actions to be taken; a transmitter/receiver 20 for transmitting and receiving information to and from the processor 30; one or more display devices 50 that are controlled through commands received from the transmitter/receiver and that can transmit feedback information back to the processor through the transmitter/receiver; and a feedback device 40 for providing feedback to the user based on measured sensory information, signals received from display devices or in response to the commands performed.

### Sensory Device

The sensory device 10 is a foot-based interface that includes one or more sensors for detecting various movements and forces from a user's foot in real time. The sensors may be pressure sensors, accelerometers, gyroscopes, or any other type of sensor that detects movement or force.

A wide range of movements and forces are available to a foot, ranging from simple movements like tapping, to more complex movements. Movements include various gestures such as swiping the big toe in any number of directions, swiping the whole foot, rocking the foot in various directions, tapping the whole foot or various parts of the foot like a heel, ball of a foot, side of a foot, or one or more toes, scrunching the toes, shaking the foot, the application of pressure in a varying pattern over a defined period of time and more. In addition to gestures, the foot can be used to apply a force to a specific area of the foot where a pressure sensor is located.

Any number of sensors can be used in the interface, from one to thousands, depending on the various foot gestures that are to be interpreted and the number of commands to be performed. The location of the sensors also depends on the foot gestures to be interpreted. For example, if a gesture includes a swiping motion of the big toe from the left to right, a plurality of pressure sensors would be needed underneath the big toe to interpret an increase in pressure moving from left to right. On the other hand, if a gesture is simply a tap of the big toe, a single pressure sensor underneath the big toe may suffice.

The foot-based interface itself may take various forms, such as an insole bed worn inside a shoe, a shoe itself, a sock, or a floor mat. In an insole bed, sensors are generally only located under the sole of the foot, whereas using a shoe or sock allows sensors to be located on non-plantar foot surfaces as well.

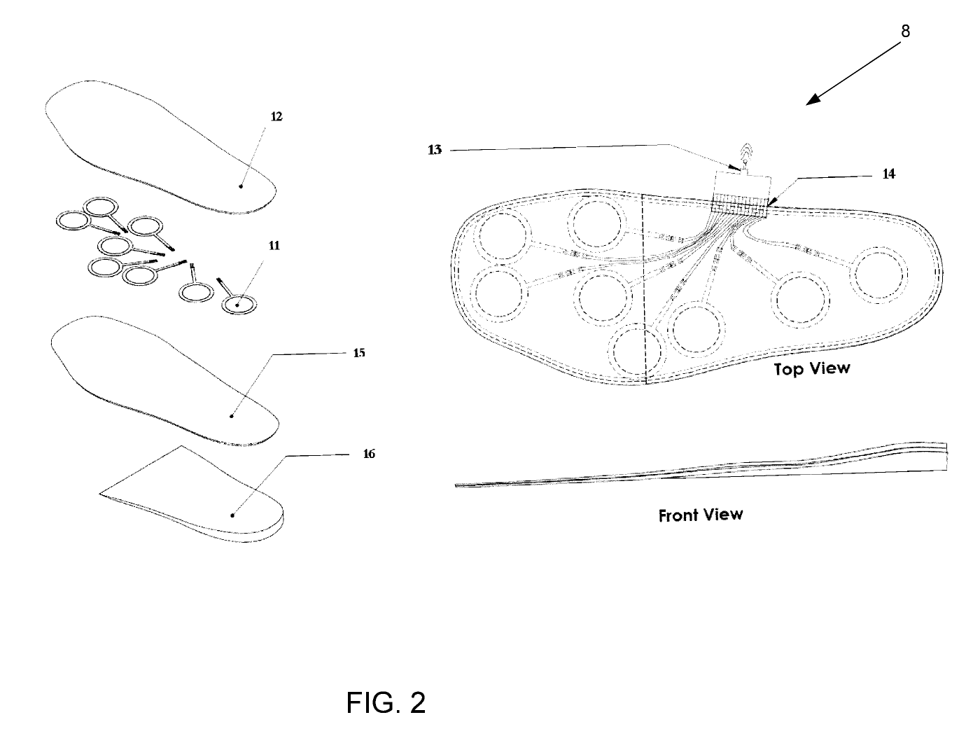

In one embodiment, illustrated in FIG. 2, the foot-based interface is an insole 8. The insole 8 comprises an array of sensors 11 distributed throughout the insole that are connected to a transmitter node 13 via a ribbon cable 14. The array of sensors 11 are positioned or laminated between an upper surface 12 and a lower cushion layer 15. A support layer 16 is provided underneath the cushion layer and may partially or wholly extend across the insole. The insole may be a generic, formed or flat insole, or a custom orthotic insole design.

### Processor

The processor 30 receives the sensory information from the sensory device 10 and uses various software algorithms to identify the information as specific foot gestures or movements and convert the gestures/movements into discrete commands that are sent to transmitter 20 to be sent to display devices 50.

The processor 30 also communicates with the feedback device 40 and the display device. For instance, the processor may provide commands to the feedback device to give specific feedback to a user based on the information received from the sensory device 10 and/or the display device 50.

Importantly, the processor doesn't simply monitor and measure the force provided at various pressure sensors in the foot-based interface, as described in the Applicant's U.S. Patent Publication No. 2012/0109013, but is able to interpret contrived command input from intentional gestures. The software algorithms analyze sensory inputs which include but are not limited to pressure, acceleration and altitude as a function of time in order to interpret various gestures. The logic of the processor may be physically embedded in the foot-based interface, the feedback device, the display device, or some combination of the foot-based interface, feedback device and display device.

Examples of various commands that may be performed include, but are not limited to, up/down, return/enter, exit, return to menu, take a picture/screenshot, take a video, stop, alphanumeric character insertion, backspace/delete, zoom in/zoom out, scroll, toggle, increase volume/decrease volume, forward/back, more/less. Specific gestures are tied to the commands, for example, pressing harder or softer on a pressure sensor underneath the big toe may cause an increase or decrease in volume on a peripheral device, and swiping the big toe from right to left may return to a previous menu.

### Transmitter/Receiver

The transmitter/receiver 20 receives information from the processor 30 and transmits it to one or more display devices 50. The transmitter/receiver 20 may also receive information from one or more display devices 50 to provide feedback through tactile or other means, as discussed in more detail below. Preferably, the transmitter is a low-profile, low energy wireless transmitter communicating through low power wireless protocols, such as, but not limited to ANT+™, ZigBee™, Gaze!™, Bluetooth™ and Bluetooth LE™ protocols.

### Feedback Device

Commands from the processor 30 are transmitted to the feedback device 40, either wirelessly or through a wired connection, in order to control the feedback device. The feedback device may provide feedback to the user through various feedback means, including but not limited to visual feedback, tactile feedback, and auditory feedback. The feedback may be provided in response to an action taken, or based on information received from an external display device, which may include a second control system in use by a second user. That is, a first user may receive feedback through their feedback device based on information about the actions of a second user.

For example, visual feedback may be provided in a display based on the gesture being performed by the user and/or the command associated with the gesture. i.e. if a user swipes their big toe from right to left, a visual display may show an animation of a big toe being swiped from right to left. Or, if a user applies a downward force under their big toe to increase the pressure and thus increase the volume on a device, the display may illustrate a volume bar increasing.

In another embodiment, the feedback may be tactile feedback, including but not limited to electrotactile, electrotextile, vibrotactile, chemotactile, temperature and/or pressure mediated stimulus. There may be one or more stimulation devices worn by the user to provide such feedback. The stimulation device(s) may be embedded in the foot-based interface, or may be worn separately by the user, such as in the form of a wristband or waist belt. In one example, if a user has increased the volume on a display device using foot commands, and the uppermost volume limit has been reached, a stimulation device in the foot may vibrate to inform the user that the end of the range has been reached. The stimulation devices may vibrate at different intensities, for different lengths of time and/or in different areas to distinguish between different feedback being provided.

### Display Device

There are one or more display devices 50 that are controlled by the system using the foot-based interface. Commands are communicated to the display device through the transmitter/receiver 20, and the display device may transmit information back to the control system through the transmitter/receiver. The information transmitted to the control system from the display device may be used to provide feedback to the user through the feedback device 40.

The display device(s) are external to the control system and may be any sort of secondary technology. The display device may include visual displays and non-visual displays, including but not limited to Google Glass™ products, any heads up display (HUD), head-mounted display (HMD) or helmet mounted display (HMD), a video game, a computer monitor, a smartwatch, a smartphone, a tablet, a surgical instrument, a surgical video display, an aeronautical instrument, a camera, a television, an automotive (such as for handicapped drivers), a home automation system, an auto mechanic instrument, a digital music player, agricultural/construction equipment, and a computer keyboard.

### In Use

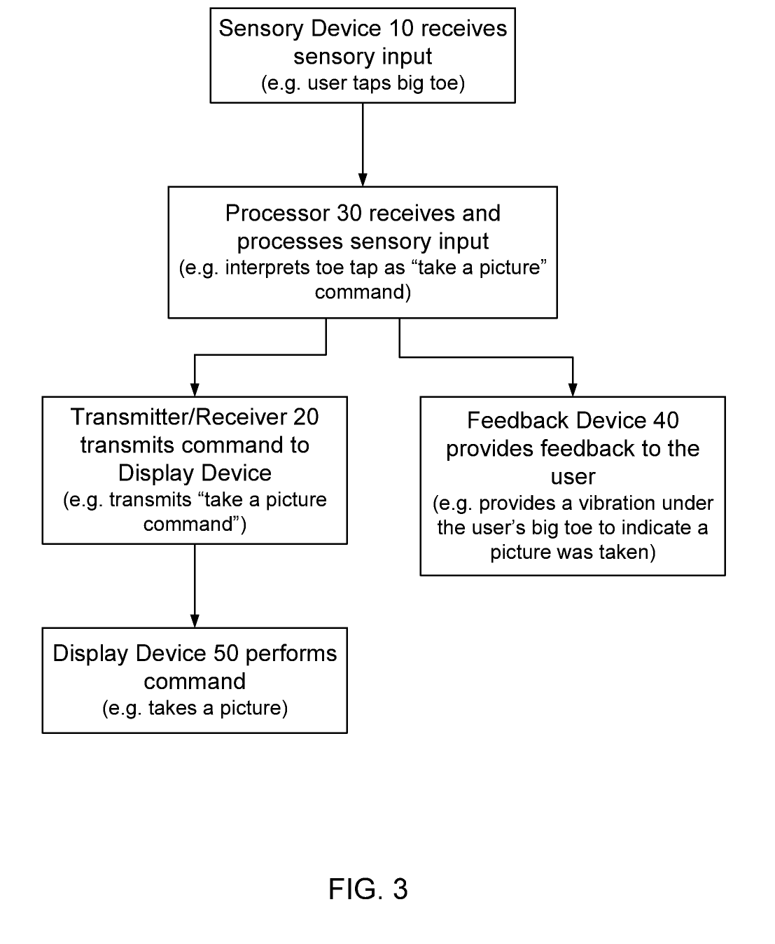

FIG. 3 illustrates one embodiment of how the various components of the control system may interact to control a display device 50 that includes picture-taking capabilities. In this example, a user wears a shoe having an insole with a pressure sensor 10 underneath their big toe. The user taps their big toe, which is detected by the pressure sensor and interpreted and recognized by the processor 30. The processor 30 then transforms the sensory information into one or more commands. A first command is sent to the display device 50 through the transmitter/receiver 20 to cause the display device 50 to take a picture. A second command is sent to the feedback device 40, which in this example is a vibratory feedback device located in the user's insole, to cause a vibration under the big toe of the user, indicating that a picture has been taken by the display device.

### Multiple Control Systems

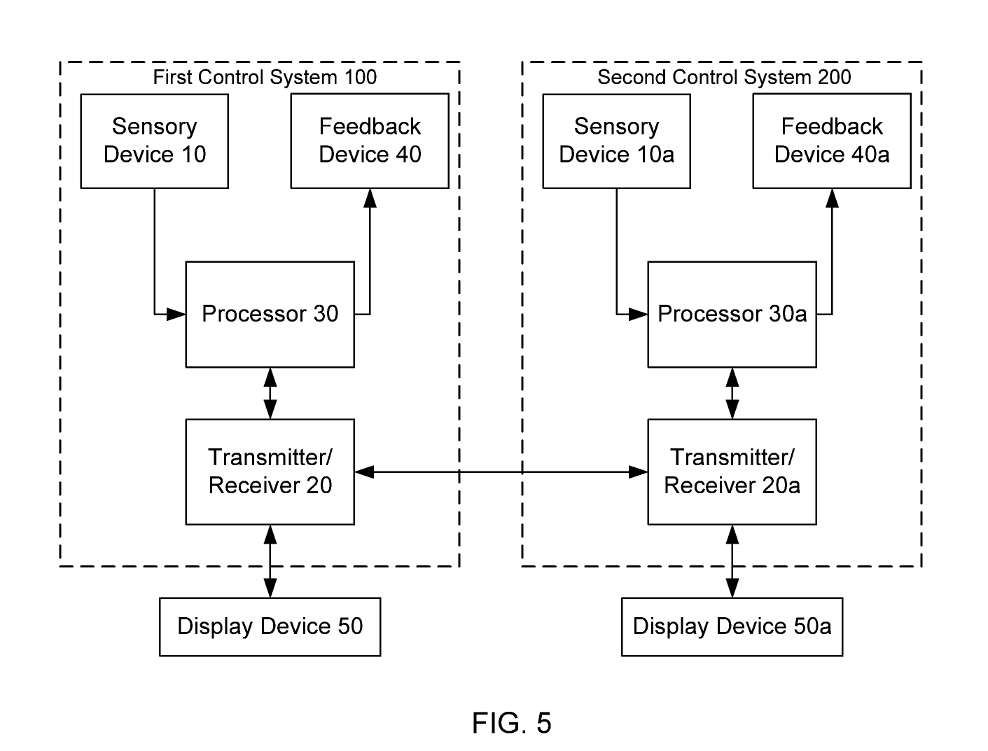

Multiple control systems used by multiple users may communicate with each other to allow for covert and discrete communication between the multiple users. The information exchanged between the users control systems may relate to actions that are taken and/or information provided by one or more display devices. FIG. 5 illustrates how a first control system 100 may communicate with a second control system 200. In this embodiment, each control system has it's own sensory device 10, 10a, feedback device 40, 40a, processor 30, 30a, and transmitter/receiver 20, 20a that are used to communicate with it's own display device 50, 50a. The transmitter/receivers 20, 20a communicate with each other to pass information back and forth between the first and second control system.

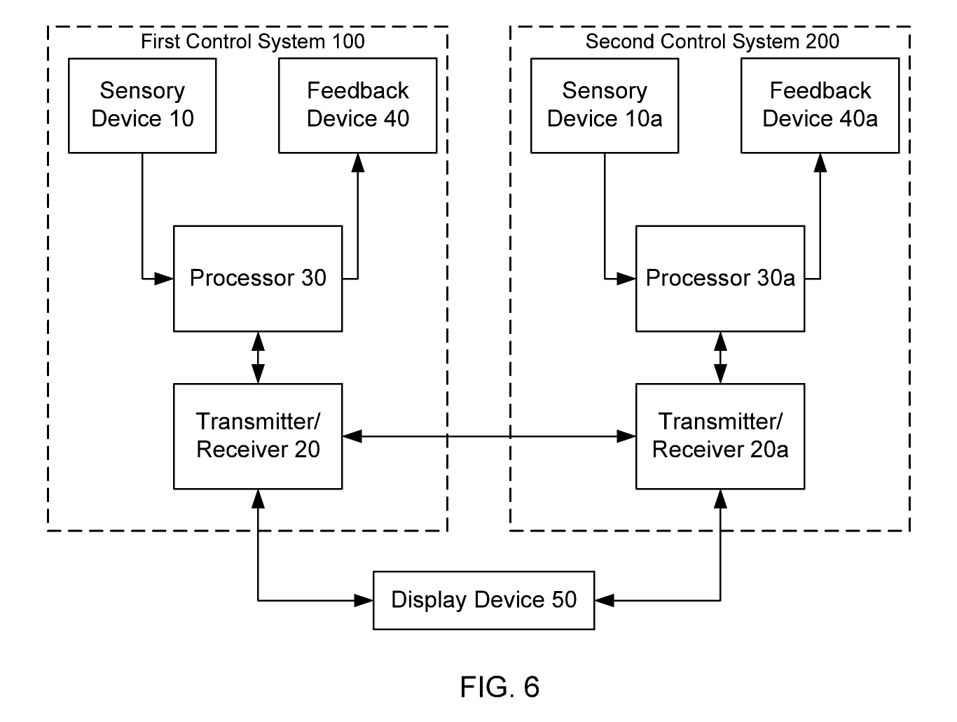

In another embodiment, shown in FIG. 6, the first and second control system 100, 200 both communicate with the same display device 50. In this embodiment, both users control the same display device, and feedback is provided from the display device to both users.

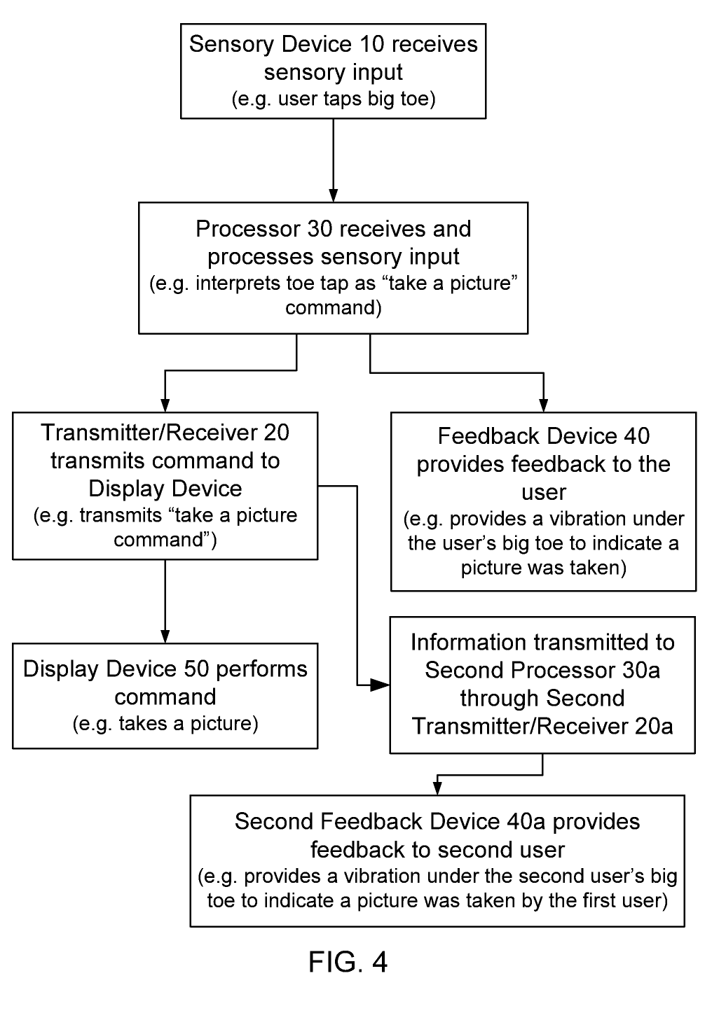

FIG. 4 illustrates an example of how feedback may be provided to a second control system in use by a second user based on an action taken by a first user using a first control system. In this example, when the first user taps their toe to take a picture with the display device, a command is transmitted to a second processor 30a via a second transmitter/receiver 20a to provide feedback through the second feedback device 40a in the form of a vibration under the second user's toe.

The feedback provided to a second user based on information from the first user is not limited to commands performed by the first user. For example, if the control systems are used in military operations, the second user may receive feedback when the first user is moving, which may be provided through GPS sensing means on the first user.

### EXAMPLES

Certain aspects of the functionality of the control system are described in the following operational examples.

### Example 1

### Use of a Foot Gesture Control Device in Controlling Information Displayed on a Heads-Up Display in a Surgical Setting and in Controlling Surgical Equipment

This example describes how an embodiment of the foot gesture device of the present invention may be used to facilitate various aspects of a surgical procedure.

In this example, two surgeons are performing excisions of gastric tumors on two different regions of the stomach of a patient. Each of the surgeons is using a heads up display (HUD) device such as Google Glass™ or a similar device (hereinafter referred to as the HUD device). The HUD device is used to provide information and control over robotic equipment to each of the surgeons upon entry of a number of different foot gestures.

The HUD device receives sensory input from the foot gesture control device and displays information within the viewing field of the surgeon so that hand or voice control is not required (an additional disadvantage of voice control is that it requires extra processing and causes rapid loss of battery power). This is particularly useful in a surgical setting because sterility of the gloved hand of a surgeon will be compromised if it touches any non-sterile surface and because surgical team members work in close quarters where voice control may be subject to interference occurring due to extraneous verbal cues from surgical team members.

In this simplified example, a number of commands to display various types of information on the HUD device are described. The skilled person will understand that these are provided by way of example only. Command gestures may be substituted and additional gestures may be added in order to expand the commands for displaying information on the HUD device.

Each of the two surgeons is equipped a HUD device which is subject to commands to display information under the control of the foot gesture control device, which uses various types of plantar pressure affecting the output of sensors to effect the commands.

For the sake of clarity, only three foot gesture commands are described. However, the skilled person will recognize that other foot gestures may be incorporated into the list of gestures used to effect various commands.

Advantageously, in this example, one command is to open a display menu from which a series of sub-menus can be opened and additional choices of commands can be made. The gestures used to effect these commands will now be briefly described.

The foot gesture of providing pressure of the tip of the hallux (big toe) causes one or more underlying sensors to issue the command of opening a main menu on the display screen of the HUD device. The menu presents a series of command choices including “vital signs,” “cameras,” “surgical models,” and “equipment.”

The action of flexion of the tip of the hallux toward the ball of the foot causes the underlying sensors of the foot gesture control device to scroll downward through the menu choices and the opposite motion of extension of the tip of the hallux away from the ball of the foot effects upward scrolling through the menu choices. The act of selecting one of the command choices is effected by downward pressure of the ball of the foot (i.e. the heads of the metatarsals).

Selection of the blood pressure data display from the vital signs menu item would thus be effected by opening the main menu (tip of hallux down); scrolling down through the menu (flexion of tip of hallux toward ball of foot until the “vital signs” choice is encountered); selecting “vital signs” (downward pressure of the ball of the foot); scrolling through the submenu (flexion of tip of hallux toward ball of foot until the “blood pressure” choice is encountered); and selecting “blood pressure” (downward pressure of the ball of the foot). The result of this action involving three different gestures is that the blood pressure of the patient is displayed on the screen of the HUD device. This is a great advantage because the surgeon will be quickly informed by peripheral vision if the patient's blood pressure changes rapidly, allowing the surgeon to react quickly, if necessary. The display of such vital sign data is obtained from a blood pressure monitor connected to a wireless transmitter for transmission to the screen of the HUD device according to known processes. Other vital sign displays may be similarly obtained by individual series of the three foot gestures described above.

During surgery involving two surgeons, it may be beneficial for one surgeon to have a brief view of what the other surgeon is doing and seeing. It is also beneficial to obtain such a view without causing a distraction to the other surgeon. For example, the first surgeon may wish to wait until a sensitive step is completed by the second surgeon before performing another sensitive step, in order to minimize risk to the patient. In such a scenario, the first surgeon opens the main menu (tip of hallux down); scrolls down through the menu (flexion of tip of hallux toward ball of foot until the “cameras” choice is encountered); selecting “cameras” (downward pressure of the ball of the foot); scrolling through the submenu (flexion of tip of hallux toward ball of foot until the “surgeon 2 camera” choice is encountered); and selecting “surgeon 2 camera” (downward pressure of the ball of the foot). The result is that a real-time video of the field of view of the second surgeon (recorded by the second surgeon's HUD device) is displayed on the screen of the HUD device of the first surgeon. The first surgeon then pauses while the second surgeon completes a sensitive surgical step, before continuing. No verbal cues between the two surgeons are necessary, allowing them to concentrate on particularly challenging surgical steps without distraction.

Surgical models are becoming increasingly useful. For example, a recent article has described heart successful heart surgery on an infant which was facilitated by 3D-printing of a model of the infant's heart. Study of this model by the surgeons prior to surgery was indicated as having contributed to the success of the procedure. Display of graphics corresponding to such a surgical model on the screen of a HUD device is another example of an “augmented reality” feature that may be used by surgeons during the course of a surgical procedure. In the present example, a number of different views of a 3D-surgical model are pre-loaded into the memory of the HUD device. In the middle of the procedure, the second surgeon wishes to consult the left lateral view of the surgical model to view the putative boundaries of the tumor in that region. The second surgeon opens the main menu (tip of hallux down); scrolls down through the menu (flexion of tip of hallux toward ball of foot until the “surgical models” choice is encountered); selecting “surgical models” (downward pressure of the ball of the foot); scrolling through the submenu (flexion of tip of hallux toward ball of foot until the “left lateral view” choice is encountered); and selecting “left lateral view” (downward pressure of the ball of the foot). The result is that a graphical representation of the left lateral view of the surgical model is displayed on the screen of the second surgeon's HUD device. The second surgeon consults this view and confirms that the visual inspection of the surgical area is closely matched to the model.

In a similar manner, certain types of surgical equipment may be remotely controlled by HUD menu choices selected using the foot gestures described above. For example, positioning of a robotic arm with a suction device and activation/deactivation of suction may be performed by the surgeon using foot gestures without the need for an assistant. Given appropriate sensitivity of the robotic arm with respect to the foot gestures, the suction device may be placed exactly where it is needed by the surgeon while concentrating on the surgical step of the moment. In this scenario, the main menu includes an item entitled “equipment” and the option “suction” is in the submenu. Selection of this item is effected using the command gestures described above. In addition, a further submenu allows the surgeon to control the movement of the robotic arm in three dimensions, as well as the rate of suction. Other types of surgical equipment amenable to control by a surgeon using a foot gesture control device may also be incorporated.

Although the present invention has been described and illustrated with respect to preferred embodiments and preferred uses thereof, it is not to be so limited since modifications and changes can be made therein which are within the full, intended scope of the invention as understood by those skilled in the art.

1. A foot gesture based control system comprising:
a sensory device having at least one sensor for generating an input based on a foot gesture or a force applied by at least one part of a user's foot;
a processor for receiving the input from the sensory device and determining any output action;
a transmitter for transmitting the output action from the processor wirelessly to at least one display device for controlling the at least one display device; and
a feedback device in communication with the processor for receiving the output action to provide feedback to the user.

2. The system of claim 1 wherein the transmitter is a transmitter/receiver, and the processor receives information from the at least one display device and/or a secondary device through the transmitter/receiver for providing feedback to the user through the feedback device.

3. The system of claim 1 wherein the sensory device is a shoe insole, a sock, a shoe or a foot mat.

4. The system of claim 1 wherein the sensory device is a shoe insole and there is an array of pressure sensors distributed throughout the insole.

5. The system of claim 1 wherein the at least one sensor is any one of or combination of a pressure sensor, accelerometer and gyroscope.

6. The system of claim 1 wherein the feedback device provides tactile feedback to the user's foot.

7. The system of claim 1 wherein the at least one display device is a head- or helmet-mounted display (HMD) or a heads up device (HUD).

8. The system of claim 1 wherein multiple foot gesture based control systems can communicate discretely with each other by sending signals using foot gestures and receiving signals through the feedback device.

9. A method for controlling a display device based on foot gestures and/or foot forces of a user comprising the steps of:
a) generating an input based on a foot gesture or foot force of the user using at least one sensor;
b) interpreting the input as a foot gesture linked to a specific command;
c) commanding a display device to perform the specific command; and
d) providing feedback to the user based on the command performed and/or information received from an external system.

10. A foot gesture-based controller for hands-free selection of a plurality of menu commands on a computer, the controller comprising:
i) a sensor device including a plurality of sensors configured to recognize a plurality of foot gestures, wherein each unique foot gesture of the plurality of foot gestures causes a unique sensor output signature configured to initiate a unique menu command from the plurality of menu commands on the computer; and
ii) a transmitter for transmitting the unique sensor output signature to the computer for initiation of the unique menu command.

11. The controller of claim 10, in the form of a shoe insole with an array of pressure sensors distributed throughout the insole.

12. The controller of claim 1, wherein the plurality of sensors includes any one of or combination of a pressure sensor, an accelerometer and a gyroscope.

13. The controller of claim 10 further comprising a feedback device for providing feedback based on the input provided and/or the generated command.

14. The controller of claim 13 wherein the feedback device provides tactile feedback to the user's foot.

15. The controller of claim 10 wherein the computer is a heads-up device (HUD) or includes a head- or helmet-mounted display.

16. The controller of claim 10, wherein the plurality of foot gestures includes any combination of two or more of the following: downward pressure of the tip of the hallux, downward pressure of the hallux combined with flexion of the hallux toward the ball of the foot, downward pressure of the hallux combined with extension of the hallux away from the ball of the foot hallux extension, downward pressure of substantially the entire ball of the foot, downward pressure of the left side of the ball of the foot, downward pressure of the right side of the ball of the foot, and downward pressure of the heel.

17. The controller of claim 10, wherein the menu commands are displayed in a main menu and in one or more submenus.

18. The controller of claim 10, wherein the menu commands are selected from the group consisting of: Open Main Menu, Scroll Up/Down, Return/Enter, Exit, Take a Photo, Take A Screenshot, Record Video, Stop Recording Video, Alphanumeric Character Insertion, Backspace/Delete, Zoom In, Zoom Out, Toggle, Increase Volume, Decrease Volume, Go Forward, Go Back, Increase Intensity, and Decrease Intensity.

19. The controller of claim 10, wherein the foot gestures recognized by the input device are pre-selected from a survey for ease of performance by a survey group of users testing the controller, and wherein the easiest foot gestures determined by the survey group are assigned to the most commonly used commands.

20. The controller of claim 10, wherein the transmitter is a wireless transmitter.

21. A use of the controller of claim 10 for providing patient data to a surgeon during surgery.

22. The use of claim 21, wherein the patient data is transmitted from a patient monitor to the computer wirelessly.

23. The use of claim 21, wherein the patient data includes any one of or a combination of vital signs data, a real time video of a different field of view of the patient, and a surgical model based on the anatomy of the patient.

24. The use of claim 23, wherein the vital signs data includes any one of or a combination of blood pressure, pulse rate, body temperature, respiration rate and dissolved oxygen level.
